(19) United States
(12) Patent Application Publication
(10) Pub. No.: US 2025/0130762 A1
(43) Pub. Date: Apr. 24, 2025

(54) DISPLAY DEVICE AND VOLUME ADJUSTMENT METHOD

(71) Applicant: HISENSE VISUAL TECHNOLOGY CO., LTD., Qingdao (CN)

(72) Inventors: Zijing DENG, Qingdao (CN); Yuanyuan CAO, Qingdao (CN)

(21) Appl. No.: 19/001,299

(22) Filed: Dec. 24, 2024

Related U.S. Application Data
(63) Continuation of application No. PCT/CN2023/098064, filed on Jun. 2, 2023.

(30) Foreign Application Priority Data
Sep. 27, 2022 (CN) 202211184993.3
Sep. 27, 2022 (CN) 202211185637.3

(51) Int. Cl. G06F 3/16; H04N 21/439; H04R 25/00

(52) U.S. Cl. CPC G06F 3/165; G06F 3/162; G06F 3/167; H04N 21/439; H04R 25/554; H04R 25/558; H04R 2420/07; H04R 2430/01

(57) ABSTRACT

The present disclosure provides a display device and a volume adjustment method. The display device includes: a display, a user interface, a communicator, a memory, and at least one processor. The at least one processor is configured for: receiving a first volume adjustment instruction; adjusting the volume of the display device according to the first volume adjustment instruction, and acquiring a first volume value and a second volume value where the display device has established a Bluetooth connection with a hearing aid supporting a HAS; and when determining according to the first volume value and the second volume value that a condition for adjusting the volume of the hearing aid is met, acquiring the loudness of ambient sounds; generating a second volume adjustment instruction according to the loudness of the ambient sounds; and sending the second volume adjustment instruction to the hearing aid by means of the Bluetooth connection.

### CROSS REFERENCE TO RELATED APPLICATION

This disclosure is a continuation application of International Application No. PCT/CN2023/098064, filed on Jun. 2, 2023, which claims priorities to Chinese Patent Application filed with the China National Intellectual Property Administration on Sep. 27, 2022, with application No. 202211184993.3, and Chinese Patent Application filed with the China National Intellectual Property Administration on Sep. 27, 2022, with application Ser. No. 20/221,1185637.3, all of which are hereby incorporated by reference in their entireties.

### TECHNICAL FIELD

The embodiments of the disclosure relate to the technical field of Bluetooth communication, and in particular to a display apparatus and a volume adjustment method.

### BACKGROUND

A hearing aid is a device that can pick up ambient sound through a microphone, amplify and reduce the noise of the picked up ambient sound, and then restore the sound to the wearer's ear to assist hearing. Since the volume of the ambient sound changes in real time, the volume of the hearing aid often needs to be adjusted during use.

Currently, the most common way to adjust the volume of the hearing aid is to adjust the volume of the hearing aid through volume adjustment buttons on the hearing aid or through an independent device to implement a hearing aid remote control (HARC) role. However, when adjusting the volume of the hearing aid through the volume adjustment buttons on the hearing aid, the hearing aid needs to be taken off to accurately operate the volume adjustment buttons, which is very inconvenient. When adjusting the volume of the hearing aid through the hearing aid remote control, it is necessary to first operate the hearing aid remote control and/or the hearing aid to establish a connection between the hearing aid remote control and the hearing aid, and then the hearing aid remote control can be further operated to adjust the volume of the hearing aid, which is also very inconvenient.

### SUMMARY

Embodiments of the present disclosure provide a display apparatus, including: a display, configured to display an image and/or a user interface; a user input interface, configured to receive a command from a user; a communicator, configured to communicate with an external device according to a predetermined protocol; a memory, configured to store computer instructions and data associated with the display apparatus; at least one processor, in connection with the display, the user input interface, the communicator and the memory, and configured to execute the computer instructions to cause the display apparatus to: receive a first volume adjustment instruction; adjust a volume of the display apparatus according to the first volume adjustment instruction, and based on that a Bluetooth connection is established between the display apparatus and a hearing aid supporting a hearing aid service (HAS), obtain a first volume value and a second volume value; where the first volume value is a volume value of the display apparatus after adjusting the volume of the display apparatus according to the first volume adjustment instruction, and the second volume value is a volume value of the hearing aid; based on that a condition for adjusting a volume of the hearing aid is met according to the first volume value and the second volume value, obtain loudness of an ambient sound; generate a second volume adjustment instruction according to the loudness of the ambient sound; and send the second volume adjustment instruction to the hearing aid via the Bluetooth connection to adjust the volume of the hearing aid.

Embodiments of the present disclosure provide a volume adjustment method, which is applied to a display apparatus, the method including: receiving a first volume adjustment instruction; adjusting a volume of the display apparatus according to the first volume adjustment instruction; based on that a Bluetooth connection is established between the display apparatus and a hearing aid supporting a hearing aid service (HAS), obtaining a first volume value and a second volume value; where the first volume value is a volume value of the display apparatus after adjusting the volume of the display apparatus according to the first volume adjustment instruction, and the second volume value is a volume value of the hearing aid; based on that a condition for adjusting a volume of the hearing aid is met according to the first volume value and the second volume value, obtaining loudness of an ambient sound; generating a second volume adjustment instruction according to the loudness of the ambient sound; and sending the second volume adjustment instruction to the hearing aid via the Bluetooth connection to adjust the volume of the hearing aid.

### BRIEF DESCRIPTION OF FIGURES

FIG. 1 is a scenario architecture diagram of a volume adjustment method according to some embodiments.

FIG. 2 is a block diagram of a hardware configuration of a control device according to some embodiments.

FIG. 3 is a block diagram of a hardware configuration of a display apparatus according to some embodiments.

FIG. 4 is a block diagram of a hardware configuration of a hearing aid according to some embodiments.

FIG. 5 is a diagram of a software configuration in a display apparatus according to some embodiments.

FIG. 6 is a software configuration diagram of an audio architecture according to some embodiments.

FIG. 7 is a flow chart of steps of a volume adjustment method according to some embodiments.

FIG. 8 is an interactive flow chart of a volume adjustment method according to some embodiments.

FIG. 9 is an interactive flow chart of another volume adjustment method according to some embodiments.

FIG. 10 is an interactive flow chart of a volume adjustment method according to some embodiments.

FIG. 11 is an interactive flow chart of another volume adjustment method according to some embodiments.

FIG. 12 is a flow chart of steps of another volume adjustment method according to some embodiments.

FIG. 13 is an interactive flow chart of another volume adjustment method according to some embodiments.

FIG. 14 is a scene interface diagram of a volume adjustment method according to some embodiments.

FIG. 15 is a scene interface diagram of another volume adjustment method according to some embodiments.

FIG. 16 is a scene interface diagram of another volume adjustment method according to some embodiments.

FIG. 17 is an interactive flow chart of another volume adjustment method according to some embodiments.

FIG. 18 is an interactive flow chart of another volume adjustment method according to some embodiments.

### DETAILED DESCRIPTION

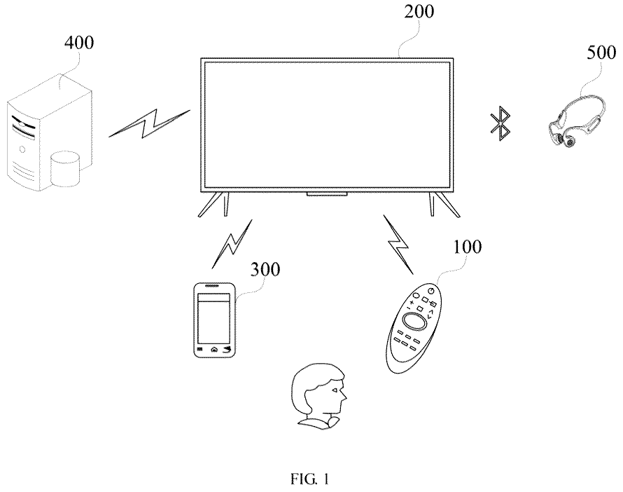

FIG. 1 is a scenario architecture diagram of a volume adjustment method in the present disclosure. The scenario architecture shown in FIG. 1 includes: a control device 100, a display apparatus 200, a terminal device 300, a server 400 and a hearing aid 500.

Users can operate the display apparatus 200 through the terminal device 300 or the control device 100. A data transmission link is established between the terminal device 200 and the server 400. The display apparatus 200 can obtain relevant media resources from the server 400 through the data transmission link. A Bluetooth connection is established between the display apparatus 200 and the hearing aid 500. The display apparatus 200 can send audio data or a third volume adjustment instruction to the hearing aid 500 through the Bluetooth connection between the display apparatus 200 and the hearing aid 500. The hearing aid 500 also sends audio data to the display apparatus 200 through the Bluetooth connection between the display apparatus 200 and the hearing aid 500.

According to some embodiments, the display apparatus 200 can have a variety of implementation forms, for example, the display apparatus 200 can be a television, a smart speaker refrigerator with a display function, a curtain with a display function, a personal computer (PC), a laser projection device, a monitor, an electronic bulletin board, a wearable device, a vehicle-mounted device, an electronic table, etc., which is not limited in the present disclosure.

In some embodiments, the control device 100 can be a remote controller. The communication between the remote controller and the display apparatus 200 can be infrared protocol communication, Bluetooth protocol communication, or other short-distance communication methods. The display apparatus 200 can be controlled wirelessly or wired. The user can input a user command through buttons on the remote controller, voice input, control panel input, etc., to control the display apparatus 200. In some embodiments, the control device 100 can also be a terminal device (such as a mobile phone, a tablet computer, a computer, a laptop computer, etc.). For example, the display apparatus 200 can be controlled using applications running on the terminal device.

In some embodiments, the display apparatus 200 can also be controlled by the terminal device 300 (such as a mobile phone, a tablet computer, a computer, a laptop computer, etc.). For example, the display apparatus 200 can be controlled by applications running on a smart device.

In some embodiments, the display apparatus 200 can also be controlled in a manner other than the control device 100. For example, the display apparatus 200 can directly receive the users' voice commands through a module for obtaining voice instructions configured inside the display apparatus 200, or receive the users' key operation through physical buttons on the display apparatus 200, or receive the users' touch operation through a touch control panel of the display apparatus 200.

In some embodiments, the display apparatus 200 can also communicate data with the server to obtain relevant media resources from the server. The display apparatus 200 can be in communication with the server through a local area network (LAN) or a wireless local area network (WLAN). The server can provide media resource services, various content and interactions to the display apparatus 200. The server can be a cluster or multiple clusters, and can include one or more types of servers.

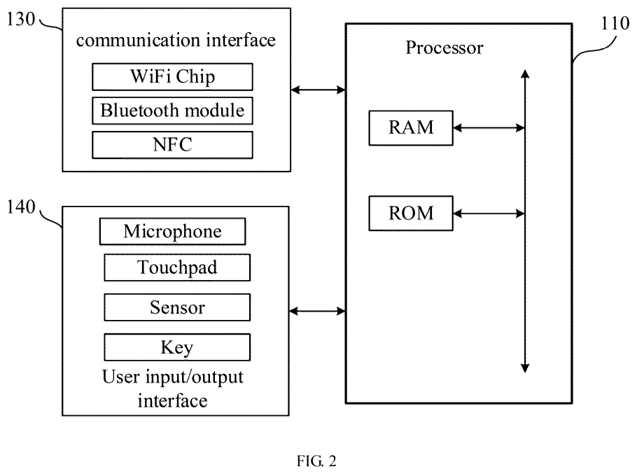

FIG. 2 is a block diagram of a configuration of the control device 100 in the embodiments shown in FIG. 1. As shown in FIG. 2, the control device 100 includes at least one of: at least one processor 110, a communication interface 130, a user input/output interface 140, a memory, and a power supply. The control device 100 can receive an operation command input from a user, convert the operation instruction into an instruction that can be recognized and responded to by the display apparatus 200, and forward the operation instruction or the instruction obtained by converting a voice instruction to the display apparatus 200, playing a role of an interactive intermediary between the user and the display apparatus 200.

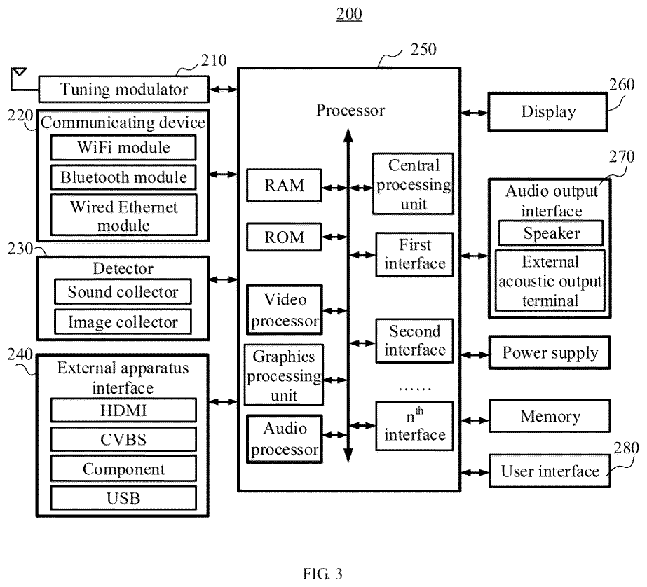

FIG. 3 is a block diagram of the configuration of the display apparatus 200 in the embodiments shown in FIG. 1. As shown in FIG. 3, the display apparatus 200 includes at least one of: a tuner and demodulator 210, a communicator 220, a detector 230, an external device interface 240, at least one processor 250, a display 260, an audio output interface 270, a memory, a power supply, and a user input interface.

In some embodiments, the tuner and demodulator 210 receives broadcast television signals by wired or wireless reception, and demodulates audio and video signals, such as EPG data signals, from multiple wireless or wired broadcast television signals. In some embodiments, the tuner and demodulator 210 can be located in different split devices, that is, the tuner and demodulator 210 can also be in an external device of a physical device where at least one processor 250 is located, such as an external set-top box.

The communicator 220 is a component for communicating with external devices (such as at least one processor 110, server 400, hearing aid 500, etc.) according to various types of communication protocols. For example, the communicator 220 can include at least one of a Wifi module, a Bluetooth module, a wired Ethernet module, and other network communication protocol chips or near field communication protocol chips, and an infrared receiver. The display apparatus 200 can send and receive control signals and data signals with external devices through the communicator 220.

The detector 230 is used to collect signals from the external environment or the external interaction. For example, the detector 230 includes a light receiver, a sensor for collecting the intensity of ambient light; or, the detector 230 includes an image collector, such as a camera, which can be used to collect external environment scenes, user attributes or user interaction gestures; or, the detector 230 includes a sound collector, such as a microphone, etc., for receiving external sounds.

The external device interface 240 can include, but is not limited to, any one or more of the following interfaces: a high-definition multimedia interface (HDMI), an analog or digital high-definition component input interface (component), a composite video input interface (CVBS), a USB input interface (USB), an RGB port, etc. The external device interface 240 can also be a composite input/output interface formed by the above multiple interfaces.

At least one processor 250 controls operations of the display apparatus and responds to users' operations through various software control programs stored in the memory. At least one processor 250 controls the overall operation of the display apparatus 200. For example, in response to receiving a user command for selecting a Ul object to be displayed on the display 260, at least one processor 250 can perform operations related to the object selected by the user command. In some embodiments, at least one processor includes at least one of a central processing unit (CPU), a video processor, an audio processor, a graphics processing unit (GPU), a random access memory (RAM), a read-only memory (ROM), a first interface to an nth interface for input/output, a communication bus, etc.

The display 260 includes a display screen component for presenting an image or a picture, a driving component for driving image display, a component for receiving an image signal output from at least one processor, a component for displaying video content, image content, and a menu control interface, and a user control Ul interface. The display 260 can be a liquid crystal display, an OLED display, and a projection display, and can also be a projection device and a projection screen. The user can input a user command in a graphical user interface (GUI) on the display 260, and the user interface receives the user command through the graphical user interface (GUI). Alternatively, the user can input a user command by inputting a specific sound or gesture, and the user interface can recognize the sound or gesture through a sensor to receive the user command. Here, the user interface is a medium interface for interaction and information exchange between an application or an operating system and a user, which realizes conversion between an internal form of information and a form acceptable to the user. The form commonly used by the user interface is a graphical user interface (GUI), which refers to a user interface associated with computer operations displayed in a graphical manner. The user interface can be an interface element such as an icon, window, control, etc., displayed on the display screen of an electronic device. The control can include visual interface elements such as icons, buttons, menus, tabs, text boxes, dialog boxes, status bars, navigation bars, widgets, etc.

The audio output interface 270 is an audio output component for outputting audio signals, including a speaker, an external audio output terminal, and the like.

The user interface can be used to receive control signals input from the user through the control device 100 (e.g., an infrared remote controller, etc.) or through touch or gesture.

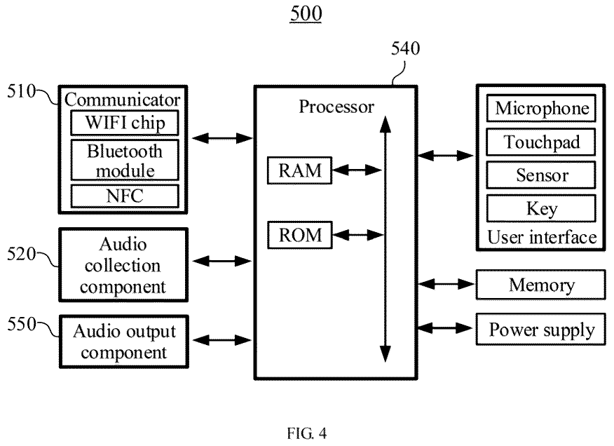

FIG. 4 is a block diagram of a configuration of the hearing aid 500 in the embodiments shown in FIG. 1. As shown in FIG. 4, the hearing aid 500 includes at least one of: a communicator 510, an audio collection component 520, an external device interface 530, at least one processor 540, an audio output component 550, a memory, a power supply, and a user interface.

In some embodiments, the hearing aid 500 can pick up ambient sound through the audio collection component 520, amplify and reduce noise on the picked up ambient sound through at least one processor 540, and output the picked up and processed ambient sound through the audio output component 550 to achieve the function of assisting hearing.

In some embodiments, the hearing aid 500 can also establish a Bluetooth connection with other devices (such as the display apparatus 200 or the terminal device 300) through the communicator 510, receive audio signals or control instructions sent from other devices through the Bluetooth connection established with other devices, and output the received audio signals through the audio output component 550, or respond to the control instructions sent from other devices through at least one processor 540. The hearing aid 500 can also send audio signals or control instructions to other devices through the Bluetooth connection established with other devices.

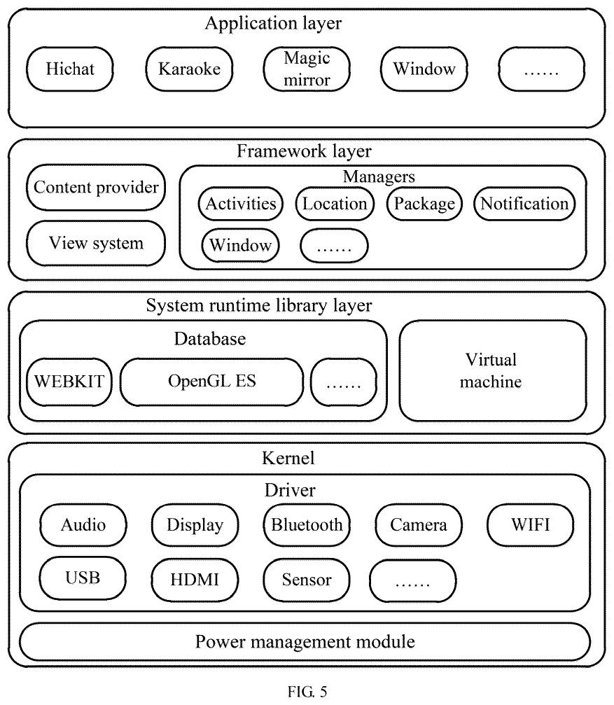

As shown in FIG. 5, in some embodiments, an operating system of the display apparatus 200 includes four layers, namely, from top to bottom, an application layer (Applications), an application framework layer (Application Framework), an Android runtime and system library layer (system runtime library layer), and a kernel layer.

In some embodiments, at least one application is running in the application layer, and these applications can be window applications, system settings applications, clock applications, etc., provided by the operating system, or applications developed by third-party developers. In specific implementations, application packages in the application layer are not limited to the above embodiments.

The application framework layer provides application programming interfaces (APIs) and programming frameworks for applications. The application framework layer includes some predefined functions. The application framework layer is equivalent to a processing center that determines actions that applications in the application layer take. Through the API interface, applications can access system resources and obtain system services during execution.

As shown in FIG. 5, the application framework layer in the embodiments of the present disclosure includes managers, content providers, etc. The manager includes at least one of the following modules: an activity manager for interacting with all activities running in the system; a location manager for providing system services or applications with access to system location services; a package manager for retrieving various information associated with applications currently installed on the device; a notification manager for controlling the display and clearing of notification messages; and a window manager for managing icons, windows, toolbars, wallpapers, and desktop widgets on the user interface.

In some embodiments, the activity manager is used to manage a life cycle of each application and a common navigation back function, such as controlling the exit, opening, and back of the application. The window manager is used to manage all window programs, such as obtaining a size of a display screen, determining whether there is a status bar, locking the screen, capturing the screen, and controlling changes of a display window (for example, reducing the display window, shaking the display, distorting the display, etc.), etc.

In some embodiments, the system runtime library layer provides support for the upper layer, namely the framework layer. When the framework layer is used, the Android operating system will run a C/C++ library contained in the system runtime library layer to implement the functions to be implemented by the framework layer.

In some embodiments, the kernel layer is a layer between hardware and software. As shown in FIG. 5, the kernel layer includes at least one of the following drivers: an audio driver, a display driver, a Bluetooth driver, a camera driver, a WIFI driver, a Universal Serial Bus (USB) driver, a High Definition Multimedia Interface (HDMI) driver, a sensor driver (such as a fingerprint sensor, a temperature sensor, a pressure sensor, etc.), and a power driver, etc.

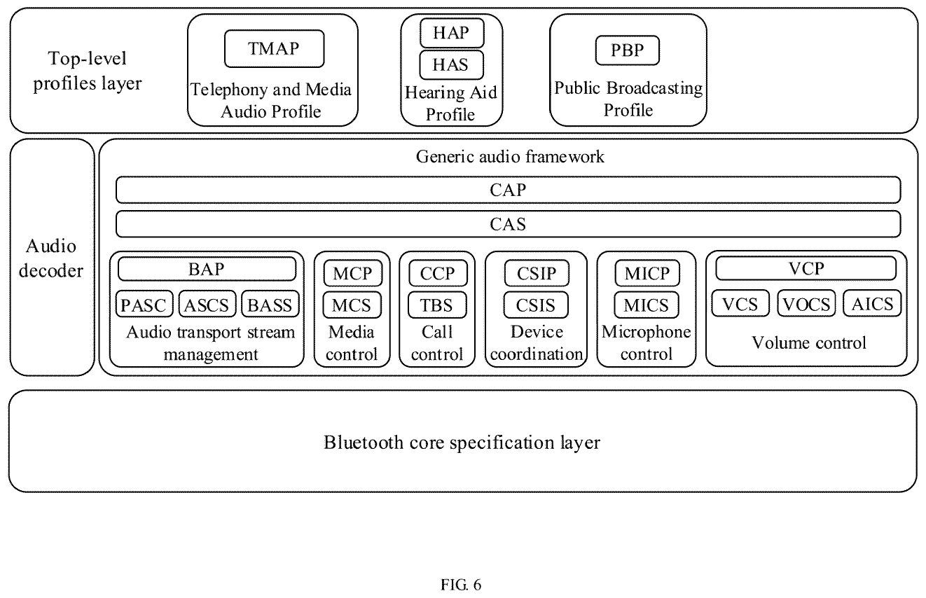

In some embodiments, the audio architecture in the embodiments of the present disclosure can be an audio architecture of Low Energy Audio (LE audio). As shown in FIG. 6, the audio architecture of LE audio can include: a top-level profiles layer, an audio decoder, a generic audio framework (GAF) layer, and a Bluetooth core specification layer.

The upper layer protocols provide additional requirements for specific audio use cases, including: Telephony and Media Audio Profile (TMAP), Hearing Aid Profile (HAP) and Hearing Aid Service (HAS), and Public Broadcasting Profiles (PBP).

The audio decoder is a low complexity communication codec LC3, which is a mandatory codec for LE audio streams. LC3 can encode audio into a single stream, so GAF can configure unicast streams to audio playback devices such as hearing aids, earbuds, and headphones to transmit only the audio required by the audio playback device.

The common audio architecture includes: Common Audio Profile (CAP), Common Audio Service (CAP), audio transport stream management, media control, call control, device coordination, microphone control, and volume control. The audio transport stream management includes: Basic Audio Profile (BAP), Published Audio Capabilities Service (PACS), Audio Stream Control Service (ASCS), and Broadcast Audio Scan Service (BASS). The media control includes: Media Control Profile (MCP) and Media Control Service (MCS). The call control includes: Call Control Profile (CCP) and Telephone Billing Service (TBS). The device coordination includes: Coordinated Set Identification Profile (CSIP) and Coordinated Set Identification Service (CSIS). The microphone control includes: Microphone Control Profile (MICP) and Microphone Control Service (MICS). The volume control includes: Volume Control Profile (VCP), Volume Control Service (VCS), Audio Input Control Service (VICS) and Volume Offset Control Service (VOCS).

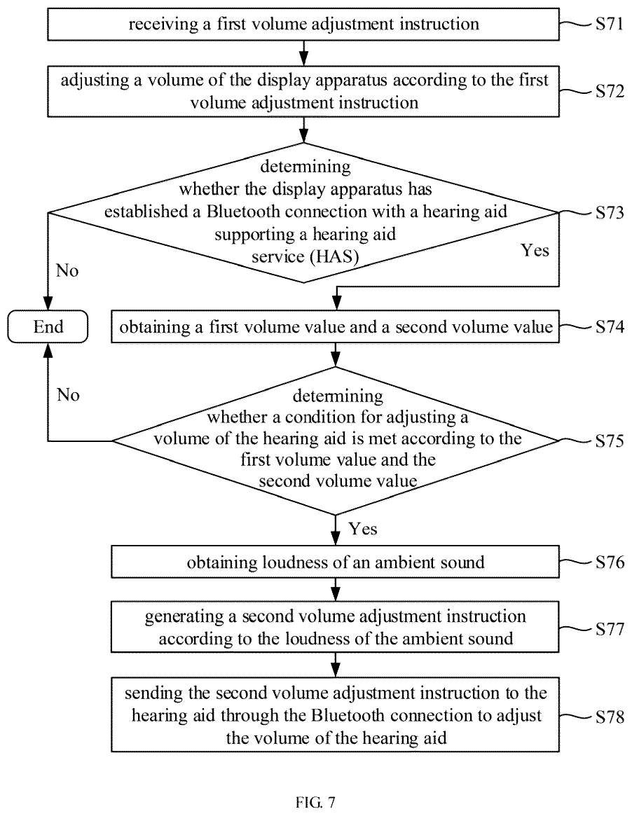

FIG. 7 is a flow chart of a volume adjustment method shown in embodiments of the present disclosure. The volume adjustment method can be performed by the display apparatus 200 in the embodiments shown in FIG. 1. As shown in FIG. 7, the method includes the following steps S71 to S78.

S71: receiving a first volume adjustment instruction.

In some embodiments, the display apparatus receiving the first volume adjustment instruction can include: the display apparatus receiving the first volume adjustment instruction sent from a remote controller or a terminal device through a user interface.

In some other embodiments, the display apparatus receiving the first volume adjustment instruction can include: the display apparatus receiving an operation from a user on a volume adjustment button of the display apparatus through a user interface, and generating the first volume adjustment instruction according to the operation from the user on the volume adjustment button.

In the embodiments of the present disclosure, the first volume adjustment instruction can be a volume adjustment instruction for increasing a volume value by a preset value, or a volume adjustment instruction for decreasing a volume value by a preset value, or a volume adjustment instruction for adjusting a volume value to a specified volume value. For example, if a “volume+” button on a remote control is operated by the user, the remote control sends a first volume adjustment instruction for increasing the volume value by 1 to the display apparatus, and accordingly, the display apparatus receives the first volume adjustment instruction for increasing the volume value by 1 sent from the remote control. For another example, if a voice receiving component on the remote control receives a voice of “adjusting the volume value to 8” input from the user, the remote control sends a first volume adjustment instruction for adjusting the volume value to 8 to the display apparatus, and accordingly, the display apparatus receives the first volume adjustment instruction for adjusting the volume value to 8 sent from the remote control.

S72: adjusting a volume of the display apparatus according to the first volume adjustment instruction.

In some embodiments of the present disclosure, when the first volume adjustment instruction is a volume adjustment instruction for increasing the volume value by 1 and the current volume value of the display apparatus is 5, the adjusting the volume of the display apparatus according to the first volume adjustment instruction includes: increasing the volume value of the display apparatus by 1 by executing the first volume adjustment instruction to adjust the volume value of the display apparatus to 6.

In some embodiments of the present disclosure, when the first volume adjustment instruction is a volume adjustment instruction for adjusting the volume value to 8 and the current volume value of the display apparatus is 5, the adjusting the volume of the display apparatus according to the first volume adjustment instruction includes: adjusting the volume value of the display apparatus from 5 to 8 by executing the first volume adjustment instruction.

S73: determining whether the display apparatus has established a Bluetooth connection with a hearing aid supporting a hearing aid service (HAS).

In some embodiments, an implementation method for determining whether the display apparatus has established the Bluetooth connection with the hearing aid supporting the hearing aid service can include that: the display apparatus determines, through at least one processor, whether a Bluetooth connection is currently established between the display apparatus and other devices; if no Bluetooth connection is currently established between the display apparatus and other devices, the display apparatus determines that the display apparatus has not established the Bluetooth connection with the hearing aid supporting the hearing aid service; and if the Bluetooth connection is currently established between the display apparatus and other devices, the display apparatus determines whether the other device is a hearing aid (HA) and whether the device supports the hearing aid service, if the device is not a hearing aid and/or the device does not support the hearing aid service, the display apparatus determines that the display apparatus has not established the Bluetooth connection with the hearing aid supporting the hearing aid service, and if the device is a hearing aid and supports the hearing aid service, the display apparatus determines that the display apparatus has established the Bluetooth connection with the hearing aid supporting the hearing aid service.

The Bluetooth connection in the embodiments of the present disclosure can be a Bluetooth connection established based on Low Energy Audio (LE audio).

It should be noted that the execution order of steps S72 and S73 is not limited in the embodiments of the present disclosure. The volume of the display apparatus can be adjusted according to the first volume adjustment instruction first, and then the display apparatus determines whether the display apparatus has established a Bluetooth connection with the hearing aid supporting the hearing aid service. Alternatively, the display apparatus can first determine whether the display apparatus has established a Bluetooth connection with the hearing aid supporting the hearing aid service, and then the volume of the display apparatus can be adjusted according to the first volume adjustment instruction. Alternatively, simultaneously, the volume of the display apparatus can be adjusted according to the first volume adjustment instruction and whether the display apparatus has established a Bluetooth connection with the hearing aid supporting the hearing aid service is determined.

It should also be noted that in the LE Audio technical specification, the hearing aid protocol defines a role of a hearing aid remote control of the hearing aid. The hearing aid remote control can send control signals, such as volume adjustment, to the hearing aid to be executed by the hearing aid. Therefore, only when the hearing aid supports the hearing aid service, the display apparatus can act as a hearing aid remote control to send volume adjustment information to the hearing aid to be executed by the hearing aid. Therefore, in the present disclosure, the display apparatus needs to determine that a Bluetooth connection has been established with a hearing aid that supports the hearing aid service before executing subsequent steps to adjust the volume of the hearing aid.

In the above step S73, if the display apparatus does not establish a Bluetooth connection with the hearing aid supporting the hearing aid service, the volume adjustment method according to some embodiments ends, and the volume of the display is adjusted only according to the received volume adjustment instruction; and if the display apparatus establishes a Bluetooth connection with the hearing aid supporting the hearing aid service, the following step S74 is executed.

S74: obtaining a first volume value and a second volume value.

The first volume value is a volume value of the display apparatus after adjusting the volume of the display apparatus according to the first volume adjustment instruction. The second volume value is a volume value of the hearing aid.

In some embodiments, the display apparatus obtains the second volume value (the volume value of the hearing aid) by: sending, by the display apparatus, volume request information to the hearing aid via the Bluetooth connection, receiving volume response information returned by the hearing aid via the Bluetooth connection, and parsing the volume response information to obtain the second volume value.

In some embodiments, the display apparatus obtains the second volume value (the volume value of the hearing aid) by: maintaining, by the display apparatus, the volume value of the hearing aid in a volume control profile (VCP) module, and reading the second volume value from the VCP module.

S75: determining whether a condition for adjusting a volume of the hearing aid is met according to the first volume value and the second volume value.

That is, whether the first volume value and the second volume value satisfy the condition for adjusting the volume of the hearing aid.

In the above step S75, if it is determined that the condition for adjusting the volume of the hearing aid is not met according to the first volume value and the second volume value, the volume adjustment method according to some embodiments ends, and if it is determined that the condition for adjusting the volume of the hearing aid is met according to the first volume value and the second volume value, the following step S76 is executed.

S76: obtaining loudness of an ambient sound.

In some embodiments, the ambient sound can be converted into an electrical signal through a microphone of the display apparatus, and the loudness of the ambient sound can be determined based on the strength of the electrical signal obtained by converting the ambient sound.

S77: generating a second volume adjustment instruction according to the loudness of the ambient sound.

In some embodiments, the second volume adjustment instruction can be a volume adjustment instruction for increasing or decreasing the volume value by a preset value. For example, the second volume adjustment instruction can be a volume adjustment instruction for increasing the volume value by 1.

In some embodiments, the second volume adjustment instruction can be a volume adjustment instruction for adjusting the volume value to a specified volume value. For example, the second volume adjustment instruction can be a volume adjustment instruction for adjusting the volume value to 8.

S78: sending the second volume adjustment instruction to the hearing aid through the Bluetooth connection to adjust the volume of the hearing aid.

In some embodiments, before sending the second volume adjustment instruction to the hearing aid through the Bluetooth connection, the display apparatus further encapsulates the second volume adjustment instruction based on a Bluetooth communication protocol between the display apparatus and the hearing aid.

In the volume adjustment method in some embodiments, when the first volume adjustment instruction is received, the volume of the display apparatus is adjusted according to the first volume adjustment instruction, and when the Bluetooth connection is established between the display apparatus and the hearing aid that supports the hearing aid service, the first volume value of the display apparatus and the second volume value of the hearing aid are obtained after the volume of the display apparatus is adjusted according to the first volume adjustment instruction; then, when it is determined that the condition for adjusting the volume of the hearing aid is met according to the first volume value and the second volume value, the loudness of the ambient sound is obtained, the second volume adjustment instruction is generated according to the loudness of the ambient sound, and the second volume adjustment instruction is sent to the hearing aid through the Bluetooth connection to adjust the volume of the hearing aid. Compared to taking off the hearing aid and adjusting the volume of the hearing aid through the volume adjustment button on the hearing aid, or adjusting the volume of the hearing aid through a separate device to implement a hearing aid remote control, in the embodiments of the present disclosure, when the hearing aid supports the hearing aid service and establishes the Bluetooth connection with the display apparatus, the display apparatus can adaptively adjust the volume of the hearing aid according to the volume value of the display apparatus, the volume value of the hearing aid and the loudness of the ambient sound. Therefore, the embodiments of the present disclosure can simplify the user operation when adjusting the volume of the hearing aid, thereby improving users' experience.

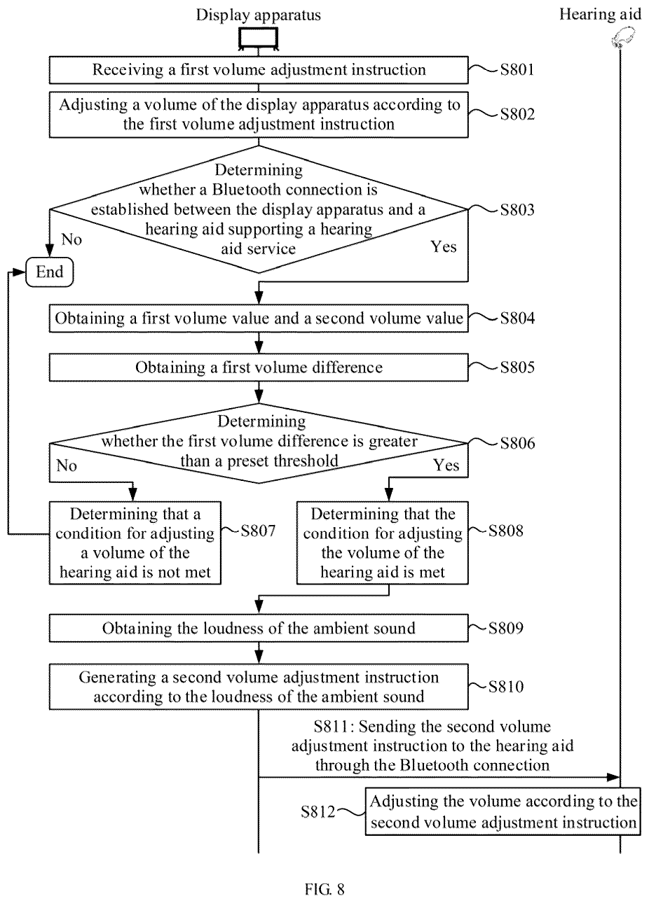

FIG. 8 is a schematic diagram of an interactive flow of a volume adjustment method shown in embodiments of the present disclosure. As shown in FIG. 8, the method includes the following steps.

S801: a display apparatus receives a first volume adjustment instruction.

S802: the display apparatus adjusts a volume of the display apparatus according to the first volume adjustment instruction.

S803: the display apparatus determines whether a Bluetooth connection is established between the display apparatus and a hearing aid supporting a hearing aid service.

In the above step S803, if the Bluetooth connection is not established between the display apparatus and the hearing aid supporting the hearing aid service, the volume adjustment method according to some embodiments ends, and the volume of the display is adjusted only according to the received volume adjustment instruction; and if the Bluetooth connection is established between the display apparatus and the hearing aid supporting the hearing aid service, the following step S804 is executed.

S804: the display apparatus obtains a first volume value and a second volume value.

The first volume value is a volume value of the display apparatus after the volume of the display apparatus is adjusted according to the first volume adjustment instruction. The second volume value is a volume value of the hearing aid.

The implementations of the above steps S801 to S804 are similar to the implementations of steps S71 to S74 in the embodiments shown in FIG. 7, which will not be described in detail here.

S805: the display apparatus obtains a first volume difference.

The first volume difference is an absolute value of a difference between the first volume value and the second volume value.

For example, after adjusting the volume of the display apparatus according to the first volume adjustment instruction, the volume value of the display apparatus is 8, and the volume value of the hearing aid is 5, then it can be determined that the first volume value is 8 and the second volume value is 5, and then the first volume difference is calculated to be 3.

For another example, after adjusting the volume of the display apparatus according to the first volume adjustment instruction, the volume value of the display apparatus is 4, and the volume value of the hearing aid is 6, then it can be determined that the first volume value is 6 and the second volume value is 4, and then the first volume difference is calculated to be 2.

S806: the display apparatus determines whether the first volume difference is greater than a preset threshold.

In the embodiments of the present disclosure, the preset threshold can be set according to synchronization requirements of the volume value of the display apparatus and the volume value of the hearing aid. If the synchronization requirement of the volume value of the display apparatus and the volume value of the hearing aid is lower, the preset threshold can be set to a larger value. If the synchronization requirement of the volume value of the display apparatus and the volume value of the hearing aid is higher, the preset threshold can be set to a smaller value.

In a certain embodiment of the present disclosure, the preset threshold can be 0, 1, 2, 3, etc. When the preset threshold is set to 0, it means that the volume value of the display apparatus is required to be completely synchronized with the volume value of the hearing aid, and as long as the volume value of the display apparatus is different from the volume value of the hearing aid, it is determined that the condition for adjusting the volume of the hearing aid is met.

In the above step S806, if the first volume difference is not greater than the preset threshold, the following step S807 is executed, and the method flow of the volume adjustment method according to some embodiments ends.

S807: the display apparatus determines that a condition for adjusting a volume of the hearing aid is not met.

In the above step S806, if the first volume difference is greater than the preset threshold, the following step S808 and subsequent steps are performed.

S808: the display apparatus determines that the condition for adjusting the volume of the hearing aid is met.

S809: the display apparatus obtains the loudness of the ambient sound.

S810: the display apparatus generates a second volume adjustment instruction according to the loudness of the ambient sound.

The implementations of the above steps S809 and S810 are similar to the implementations of steps S76 and S77 in the embodiments shown in FIG. 7, and will not be described in detail here.

S811: the display apparatus sends the second volume adjustment instruction to the hearing aid through the Bluetooth connection.

Correspondingly, the hearing aid receives the second volume adjustment instruction sent from the display apparatus through the Bluetooth connection.

S812: the hearing aid adjusts the volume according to the second volume adjustment instruction.

In the above embodiments, when the difference between the volume value of the display apparatus and the volume value of the hearing aid is greater than a preset threshold, the loudness of the ambient sound is obtained, and a second volume adjustment instruction is generated according to the loudness of the ambient sound, and the second volume adjustment instruction is sent to the hearing aid through the Bluetooth connection to adjust the volume of the hearing aid. Therefore, in the above embodiments, the display apparatus can adaptively adjust the volume value of the hearing aid according to the volume value of the display apparatus and the ambient sound, so that the volume value of the hearing aid matches the loudness of the ambient sound.

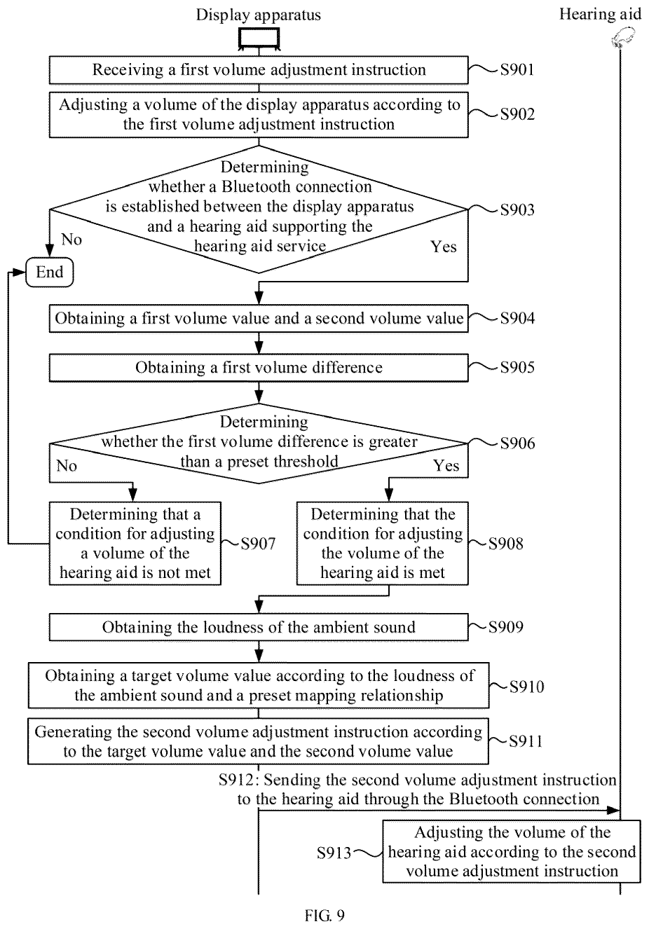

FIG. 9 is a schematic diagram of an interactive flow of a volume adjustment method shown in embodiments of the present disclosure. As shown in FIG. 9, the method includes the following steps.

S901: a display apparatus receives a first volume adjustment instruction.

S902: the display apparatus adjusts a volume of the display apparatus according to the first volume adjustment instruction.

S903: the display apparatus determines whether a Bluetooth connection is established between the display apparatus and a hearing aid supporting the hearing aid service.

In the above step S903, if the Bluetooth connection is not established between the display apparatus and the hearing aid supporting the hearing aid service, the above volume adjustment process ends, and the volume of the display is adjusted only according to the received volume adjustment instruction. If the Bluetooth connection is established between the display apparatus and the hearing aid supporting the hearing aid service, the following step S904 is executed.

S904: the display apparatus obtains a first volume value and a second volume value.

The first volume value is a volume value of the display apparatus after the volume of the display apparatus is adjusted according to the first volume adjustment instruction. The second volume value is the volume value of the hearing aid.

The implementations of the above steps S901 to S904 are similar to the implementations of steps S71 to S74 in the embodiments shown in FIG. 7, and will not be described in detail here.

S905: the display apparatus obtains a first volume difference.

The first volume difference is an absolute value of a difference between the first volume value and the second volume value.

For example, after adjusting the volume of the display apparatus according to the first volume adjustment instruction, the volume value of the display apparatus is 8, and the volume value of the hearing aid is 5, then it can be determined that the first volume value is 8 and the second volume value is 5, and then the first volume difference is calculated to be 3.

For another example, after the volume of the display apparatus is adjusted according to the first volume adjustment instruction, the volume value of the display apparatus is 4, and the volume value of the hearing aid is 6, then it can be determined that the first volume value is 6 and the second volume value is 4, and then the first volume difference is calculated to be 2.

S906: the display apparatus determines whether the first volume difference is greater than a preset threshold.

In the embodiments of the present disclosure, the preset threshold can be set according to the synchronization requirements of the volume value of the display apparatus and the volume value of the hearing aid. If the synchronization requirement of the volume value of the display apparatus and the volume value of the hearing aid is lower, the preset threshold can be set to a larger value; and if the synchronization requirement of the volume value of the display apparatus and the volume value of the hearing aid is higher, the preset threshold can be set to a smaller value.

In a certain embodiment of the present disclosure, the preset threshold can be 0, 1, 2, 3, etc. When the preset threshold is set to 0, it means that the volume value of the display apparatus is required to be completely synchronized with the volume value of the hearing aid, and as long as the volume value of the display apparatus is different from the volume value of the hearing aid, it is determined that the condition for adjusting the volume of the hearing aid is met.

In the above step S906, if the first volume difference is not greater than the preset threshold, the following step S907 is executed, and the method flow of the volume adjustment method according to some embodiments ends.

S907: the display apparatus determines that the condition for adjusting the volume of the hearing aid is not met.

In the above step S906, if the first volume difference is greater than the preset threshold, the following step S908 and subsequent steps are performed.

S908: the display apparatus determines that the condition for adjusting the volume of the hearing aid is met.

S909: the display apparatus obtains the loudness of the ambient sound.

S910: the display apparatus obtains a target volume value according to the loudness of the ambient sound and a preset mapping relationship.

The preset mapping relationship includes a mapping relationship between the loudness and volume value of each ambient sound.

In some embodiments, the preset mapping relationship can be stored in the display apparatus in the form of a corresponding relationship table, and the display apparatus obtains the target volume value according to the loudness of the ambient sound and the preset mapping relationship, including: obtaining the volume value corresponding to the loudness of the ambient sound as the target volume value by looking up the table.

In some embodiments of the present disclosure, when the preset mapping relationship is a mapping relationship table, the mapping relationship table can be as shown in the following Table 1.

TABLE 1

| | |
|---|---|
| Loudness of ambient sound | Corresponding volume value |

| | | |
|---|---|---|
| [0, 20] | dB | 1 |
| (20, 30] | dB | 2 |
| (30, 35] | dB | 3 |
| (35, 40] | dB | 4 |
| (40, 45] | dB | 5 |
| (45, 50] | dB | 6 |
| (55, 60] | dB | 7 |
| (65, 70] | dB | 8 |
| (70, 80] | dB | 9 |
| (80, +∞] | dB | 10 |

If the preset mapping relationship is as shown in Table 1 above, when the loudness of the ambient sound is 58 dB, the target volume value can be determined to be 7; when the loudness of the ambient sound is 47 dB, the target volume value can be determined to be 6.

S911: the display apparatus generates the second volume adjustment instruction according to the target volume value and the second volume value.

In some embodiments, the generating the second volume adjustment instruction according to the target volume value and the second volume value includes the following steps a and b.

Step a: obtaining a second volume difference.

The second volume difference is an absolute value of a difference between the target volume value and the second volume value.

In some embodiments of the present disclosure, the target volume value is 7, and the second volume value (the volume value of the hearing aid) is 5, then the second volume difference can be 2.

In some embodiment of the present disclosure, the target volume value is 3, and the second volume value (the volume value of the hearing aid) is 6, then the second volume difference can be 3.

Step b: generate one or more volume adjustment instructions for controlling the volume value of the hearing aid to increase or decrease, where the number of the volume adjustment instructions is equal to a value of the second volume difference.

In some embodiments of the present disclosure, the target volume value is 7, and the second volume value is 5, then the second volume difference can be 2, and two volume adjustment instructions are generated for controlling the volume value of the hearing aid to increase by 1.

In some embodiments of the present disclosure, the target volume value is 3, and the second volume value is 6, then the second volume difference can be 3, and 3 volume adjustment instructions are generated for controlling the volume value of the hearing aid to decrease by 1.

S912: the display apparatus sends the second volume adjustment instruction to the hearing aid through the Bluetooth connection.

Correspondingly, the hearing aid receives the second volume adjustment instruction sent from the display apparatus through the Bluetooth connection.

S913: the volume of the hearing aid is adjusted according to the second volume adjustment instruction.

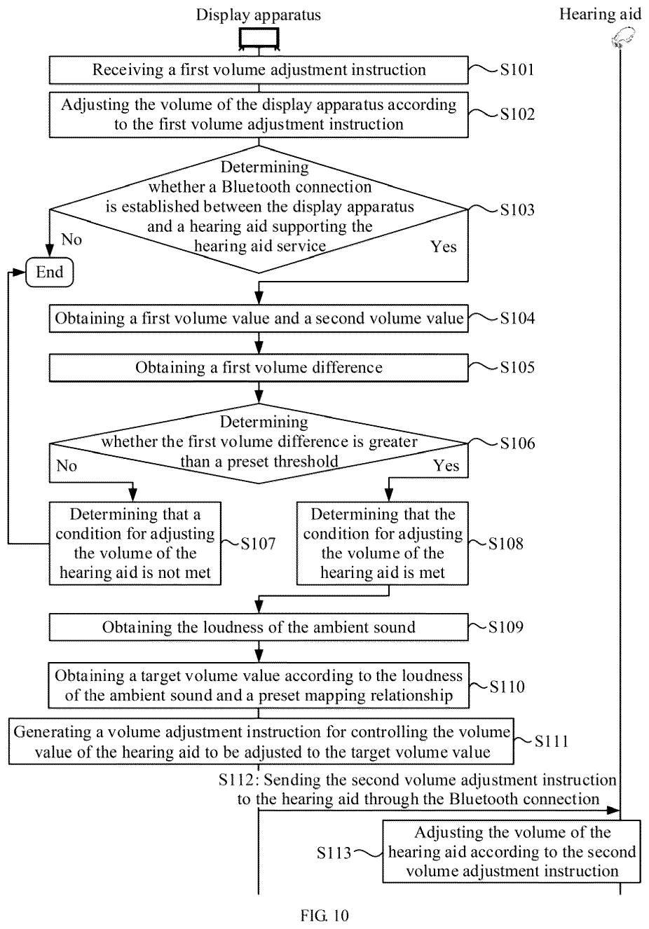

FIG. 10 is a schematic diagram of an interactive flow of a volume adjustment method shown in the embodiments of the present disclosure. As shown in FIG. 10, the method includes the following steps.

S101: a display apparatus receives a first volume adjustment instruction.

S102: the display apparatus adjusts the volume of the display apparatus according to the first volume adjustment instruction.

S103: the display apparatus determines whether a Bluetooth connection is established between the display apparatus and a hearing aid supporting the hearing aid service.

In the above step S103, if the Bluetooth connection is not established between the display apparatus and the hearing aid supporting the hearing aid service, the volume adjustment method according to some embodiments ends, and the volume of the display is adjusted only according to the received volume adjustment instruction, and if the Bluetooth connection is established between the display apparatus and the hearing aid supporting the hearing aid service, the following step S104 is executed.

S104: the display apparatus obtains a first volume value and a second volume value.

The first volume value is the volume value of the display apparatus after the volume of the display apparatus is adjusted according to the first volume adjustment instruction, and the second volume value is the volume value of the hearing aid.

The implementations of the above steps S101 to S104 are similar to the implementations of steps S71 to S74 in the embodiments shown in FIG. 7, and will not be described in detail here.

S105: the display apparatus obtains a first volume difference.

The first volume difference is an absolute value of a difference between the first volume value and the second volume value.

S106: the display apparatus determines whether the first volume difference is greater than a preset threshold.

In the above step S106, if the first volume difference is not greater than the preset threshold, the following step S107 is executed, and the method flow of the volume adjustment method according to some embodiments ends.

S107: the display apparatus determines that a condition for adjusting the volume of the hearing aid is not met.

In the above step S106, if the first volume difference is greater than the preset threshold, the following step S108 and subsequent steps are performed.

S108: the display apparatus determines that a condition for adjusting the volume of the hearing aid is met.

S109: the display apparatus obtains the loudness of the ambient sound.

S110: the display apparatus obtains a target volume value according to the loudness of the ambient sound and a preset mapping relationship.

The preset mapping relationship includes a mapping relationship between the loudness and volume value of each ambient sound.

S111: the display apparatus generates a volume adjustment instruction for controlling the volume value of the hearing aid to be adjusted to the target volume value.

In some embodiments of the present disclosure, the target volume value is 8, and a volume adjustment instruction for controlling the volume value of the hearing aid to be adjusted to 8 can be generated.

In some embodiments of the present disclosure, the target volume value is 6, and a volume adjustment instruction for controlling the volume value of the hearing aid to be adjusted to 6 can be generated.

S112: the display apparatus sends the second volume adjustment instruction to the hearing aid through the Bluetooth connection.

Correspondingly, the hearing aid receives the second volume adjustment instruction sent from the display apparatus through the Bluetooth connection.

S113: the volume of the hearing aid is adjusted according to the second volume adjustment instruction.

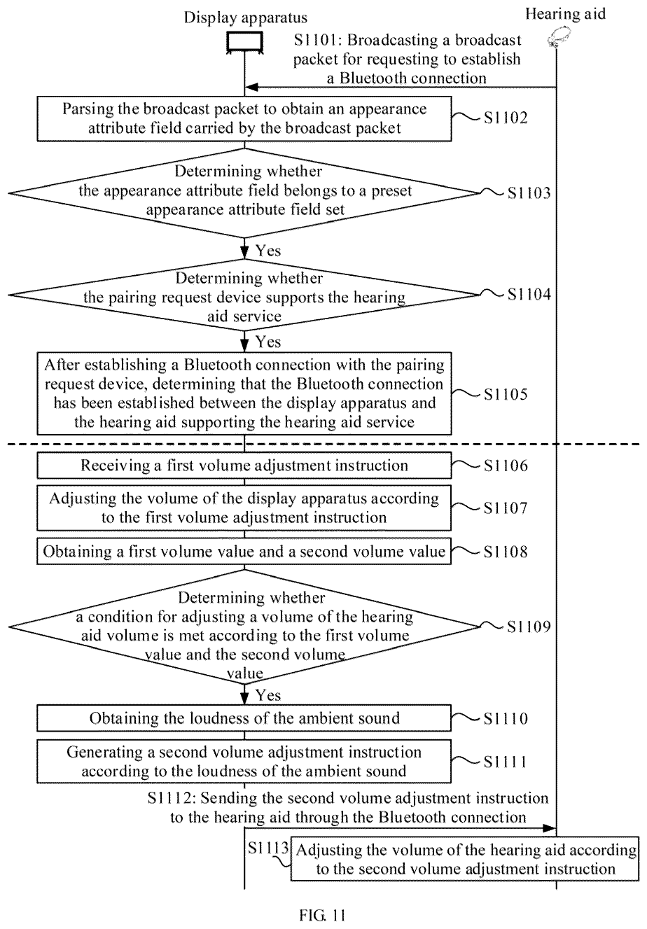

FIG. 11 is a schematic diagram of an interactive flow of another volume adjustment method shown in embodiments of the present disclosure. As shown in FIG. 11, the method includes the following steps.

S1101: the hearing aid broadcasts a broadcast packet for requesting to establish a Bluetooth connection.

The broadcast packet carries an appearance attribute field of the hearing aid.

In some embodiments of the present disclosure, when the hearing aid is a hearing aid of no special type, the appearance attribute field carried by the broadcast packet can be “Hearing Aid”; when the hearing aid is a generic hearing aid, the appearance attribute field carried by the broadcast packet can be “Generic Hearing Aid”; when the hearing aid is an in-ear hearing aid, the appearance attribute field carried by the broadcast packet can be “In-ear Hearing Aid”; when the hearing aid is a behind-the-ear hearing aid, the appearance attribute field carried by the broadcast packet can be “Behind-ear Hearing Aid”.

Since the broadcast packet is sent by broadcasting, when the display apparatus is located in a sending range of the broadcast packet of the hearing aid, the display apparatus can receive the broadcast packet sent from the hearing aid for requesting to establish a Bluetooth connection with the display apparatus.

S1102: the display apparatus parses the broadcast packet to obtain an appearance attribute field carried by the broadcast packet.

That is, the display apparatus extracts a field corresponding to the appearance attribute field according to a Bluetooth configuration protocol, thereby obtaining the appearance attribute field carried by the broadcast packet.

S1103: the display apparatus determines whether the appearance attribute field belongs to a preset appearance attribute field set.

The preset appearance attribute field set includes appearance attribute fields of at least one type of hearing aid.

It should be noted that in order to more accurately identify whether a Bluetooth pairing device is a hearing aid, the preset appearance attribute field set should include appearance attribute fields of various types of hearing aids as much as possible. In some embodiments, the preset appearance attribute field set can include appearance attribute fields of hearing aids such as “Hearing Aid”, “Generic Hearing Aid”, “In-ear Hearing Aid”, and “Behind-ear Hearing Aid”.

In the above step S1103, if the appearance attribute field does not belong to the preset appearance attribute field set, it can be determined that the current pairing request device is not a hearing aid, so the current device connected in Bluetooth can be marked as not a hearing aid through a system attribute method, and synchronized to an audio control module, and a Bluetooth connection is established with the pairing request device. When a volume adjustment instruction is received later, the audio control module only adjusts the volume of the display apparatus according to the received volume adjustment instruction.

In the above step S1103, if the appearance attribute field belongs to the preset appearance attribute field set, the following step S1104 is executed.

S1104: the display apparatus determines whether the pairing request device supports the hearing aid service.

In some embodiments, the implementations of the display apparatus determining whether the pairing request device (hearing aid) supports the hearing aid service can include the following steps 1 to 5.

Step 1: the display apparatus sends a service query request to the pairing request device during the process of establishing a Bluetooth connection between the display apparatus and the pairing request device.

Step 2: the pairing request device sends a service query response to the display apparatus.

The service query response carries a universally unique identifier (UUID) of each service supported by the pairing request device.

That is, if the hearing aid supports HAS, a UUID of HAS is carried in the service query response, and if the hearing aid does not support HAS, the UUID of HAS is not carried in the service query response.

In some embodiments, the display apparatus can send a service query request to the pairing request device via an attribute protocol (ATT), and the pairing request device can also send a service query response to the display apparatus via ATT.

In some embodiments, the service query response can be as shown in Table 2 below.

TABLE 2

| UUID | Name of Service |
|---|---|
| 0x1800 | Generic Access |
| 0x1801 | Generic Attribute |
| 0x1803 | Link Loss |
| 0x1804 | Tx Power |
| 0x1853 | Common Audio Service |
| 0x1854 | Hearing Access Service |
| 0x1855 | TMAS Service |
| . . . | . . . |

Step 3: determining whether the service query response carries the universally unique identifier of the hearing aid service.

In some embodiments, the UUID of the hearing aid service is 0×1855, so determining whether the service query response carries the universally unique identifier of the hearing aid

In the above step 3, if the service query response carries the universally unique identifier of the hearing aid service, then the following step 4 is executed, and if the service query response does not carry the universally unique identifier of the hearing aid service, then the following step 5 is executed.

Step 4: the display apparatus determines that the pairing request device supports the hearing aid service.

Step 5: the display apparatus determines that the pairing request device does not support the hearing aid service.

If the display apparatus determines that the pairing request device supports the hearing aid service, the display apparatus can mark the current device connected in Bluetooth as a hearing aid that supports the hearing aid service through system attribute method, and synchronize the device to an audio control module. If the display apparatus determines that the pairing request device does not support the hearing aid service, the display apparatus can mark the current device connected in Bluetooth as a hearing aid that does not support the hearing aid service through the system attribute method, and synchronize the device to the audio control module.

In the above step S1104, if the display apparatus determines that the pairing request device supports the hearing aid service, the following step S1105 is executed.

S1105: after establishing a Bluetooth connection with the pairing request device, the display apparatus determines that the Bluetooth connection has been established between the display apparatus and the hearing aid supporting the hearing aid service.

S1106: the display apparatus receives a first volume adjustment instruction.

S1107: the display apparatus adjusts the volume of the display apparatus according to the first volume adjustment instruction.

S1108: the display apparatus obtains a first volume value and a second volume value.

S1109: the display apparatus determines whether a condition for adjusting a volume of the hearing aid volume is met according to the first volume value and the second volume value.

In the above step S1109, if it is determined that the condition for adjusting the volume of the hearing aid is not met according to the first volume value and the second volume value, the volume adjustment method according to some embodiments ends, and if it is determined that the condition for adjusting the volume of the hearing aid is met according to the first volume value and the second volume value, the following step S1110 is executed.

S1110: the display apparatus obtains the loudness of the ambient sound.

S1111: the display apparatus generates a second volume adjustment instruction according to the loudness of the ambient sound.

S1112: the display apparatus sends the second volume adjustment instruction to the hearing aid through the Bluetooth connection.

Correspondingly, the hearing aid receives the second volume adjustment instruction sent from the display apparatus through the Bluetooth connection.

S1113: the volume of the hearing aid is adjusted according to the second volume adjustment instruction.

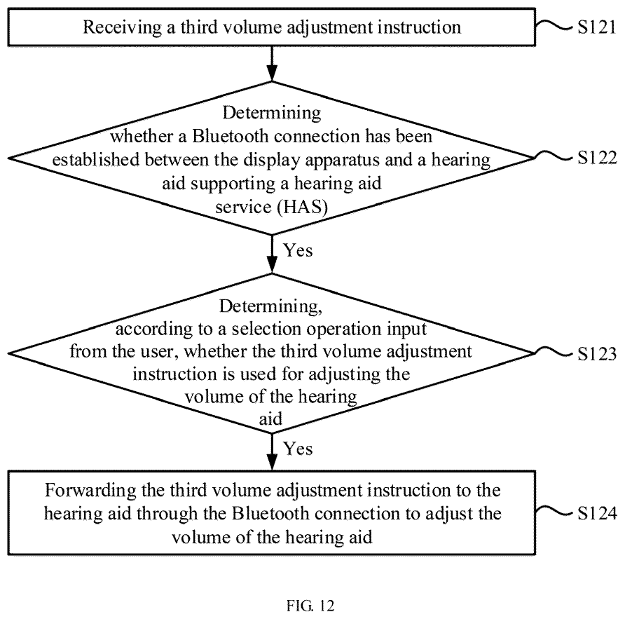

FIG. 12 is a schematic flow chart showing a volume adjustment method in the embodiments of the present disclosure. The volume adjustment method can be performed by the display apparatus 200 in the embodiments shown in FIG. 1. As shown in FIG. 12, the method includes the following steps.

S121: receiving a third volume adjustment instruction.

In some embodiments, the display apparatus receiving the third volume adjustment instruction can include: the display apparatus receiving the third volume adjustment instruction sent by a remote controller or a terminal device through a user interface.

In other embodiments, the display apparatus receiving the third volume adjustment instruction can include: the display apparatus receiving an operation from a user on a volume adjustment button of the display apparatus through a user interface, and generating the third volume adjustment instruction according to the operation from the user on the volume adjustment button.

The third volume adjustment instruction in the embodiments of the present disclosure can be a third volume adjustment instruction for increasing the volume value by a preset value, or a third volume adjustment instruction for decreasing the volume value by a preset value, or a third volume adjustment instruction for adjusting the volume value to a specified volume value. For example, when a user operates a “volume+” button on the remote control, the remote control sends a third volume adjustment instruction for increasing the volume value by 1 to the display apparatus; in response to the operation, the display apparatus receives the third volume adjustment instruction for increasing the volume value by 1 sent from the remote control.

S122: determining whether a Bluetooth connection has been established between the display apparatus and a hearing aid supporting a hearing aid service (HAS).

In some embodiments, the determining whether the Bluetooth connection has been established between the display apparatus and the hearing aid supporting the hearing aid service can include: determining, by the display apparatus, through at least one processor, whether a Bluetooth connection is currently established between the display apparatus and other devices; if the Bluetooth connection is currently not established between the display apparatus and other devices, determining that the display apparatus has not established a Bluetooth connection with the hearing aid supporting the hearing aid service; and if the Bluetooth connection is currently established between the display apparatus and other devices, determining whether the device is a hearing aid (HA) and whether the device supports the hearing aid services, if the device is not a hearing aid and/or the device does not support the hearing aid services, determining that the display apparatus has not established a Bluetooth connection with the hearing aid supporting the hearing aid service, and if the device is a hearing aid and supports the hearing aid service, determining that the display apparatus has established a Bluetooth connection with the hearing aid supporting the hearing aid service.

It should be noted that in the LE Audio technical specification, the hearing aid protocol defines a role of a hearing aid remote control of the hearing aid. The hearing aid remote control can send control signals, such as volume adjustment, to the hearing aid to be executed by the hearing aid. Therefore, only when the hearing aid supports the hearing aid service, the display apparatus can act as a hearing aid remote control to send volume adjustment information to the hearing aid to be executed by the hearing aid. Therefore, in the present disclosure, the display apparatus needs to determine that a Bluetooth connection has been established with a hearing aid that supports the hearing aid service before executing subsequent steps to adjust the volume of the hearing aid.

The Bluetooth connection in the embodiments of the present disclosure can be a Bluetooth connection established based on Low Energy Audio (LE audio).

In the above step S122, if the display apparatus has established a Bluetooth connection with the hearing aid supporting the hearing aid service, the following step S123 is executed.

S123: determining, according to a selection operation input from the user, whether the third volume adjustment instruction is used for adjusting the volume of the hearing aid.

In some embodiments, the display apparatus can display a volume adjustment object selection interface through the display apparatus, and determine whether the third volume adjustment instruction is used for adjusting the volume of the hearing aid according to a selection operation input from the user in the volume adjustment object selection interface.

In other embodiments, the display apparatus can also output voice information through the audio output interface to prompt the user to select whether the third volume adjustment instruction is used for adjusting the volume of the hearing aid, and obtain at least one of voice instructions, gestures, posture, body movements, etc., input from the user through a detector, and determine whether the third volume adjustment instruction is used for adjusting the volume of the hearing aid based on the input of the user.

In the above step S123, if the third volume adjustment instruction is used for adjusting the volume of the hearing aid, the following step S124 is executed.

S124: forwarding the third volume adjustment instruction to the hearing aid through the Bluetooth connection to adjust the volume of the hearing aid.

In some embodiments, before forwarding the third volume adjustment instruction to the hearing aid through the Bluetooth connection, the display apparatus further encapsulates the third volume adjustment instruction based on a Bluetooth communication protocol between the display apparatus and the hearing aid.

According to some embodiments, in the volume adjustment method, the third volume adjustment instruction is received, it is first determined whether the display apparatus has established a Bluetooth connection with the hearing aid supporting the hearing aid service, and when the display apparatus has established a Bluetooth connection with the hearing aid supporting the hearing aid service, it is determined whether the third volume adjustment instruction is used to adjust the volume of the hearing aid according to the selection operation input from the user, and when the third volume adjustment instruction is used to adjust the volume of the hearing aid, the third volume adjustment instruction is forwarded to the hearing aid through the Bluetooth connection to adjust the volume of the hearing aid. Compared with taking off the hearing aid and adjusting the volume of the hearing aid through the volume adjustment button on the hearing aid, or adjusting the volume of the hearing aid through a separate device to implement a hearing aid remote control, in the embodiments of the present disclosure, when the hearing aid supports the hearing aid service and has established a Bluetooth connection with the display apparatus, the display apparatus can adjust the volume of the hearing aid according to the selection operation from the user. Therefore, the embodiments of the present disclosure can simplify the user operation when adjusting the volume of the hearing aid, thereby improving the user experience.

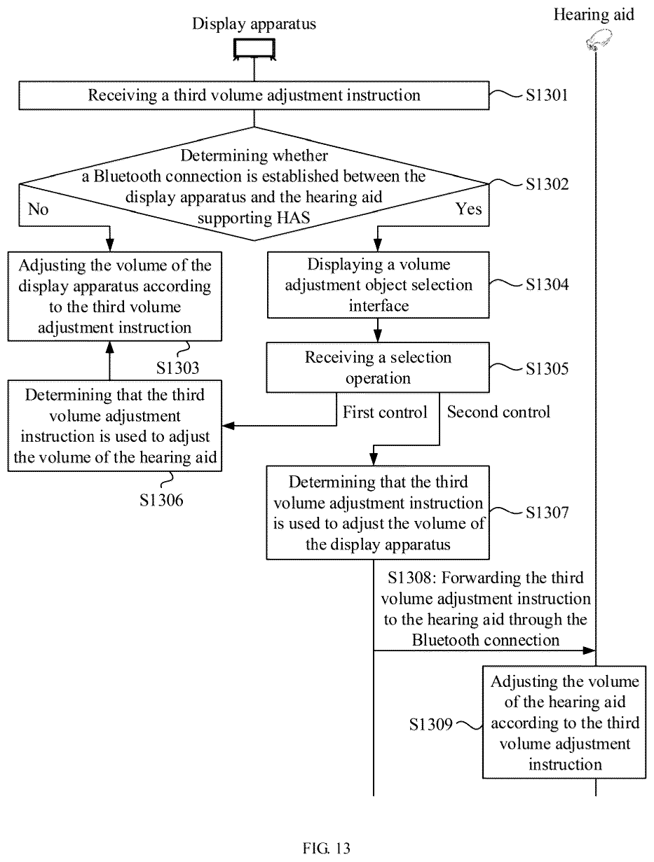

FIG. 13 is a schematic diagram of an interactive flow of a volume adjustment method shown in embodiments of the present disclosure. As shown in FIG. 13, the method includes the following steps.

S1301: the display apparatus receives a third volume adjustment instruction.

In the following embodiments, the third volume adjustment instruction is taken as an example to describe the third volume adjustment instruction for increasing the volume value by 1.

S1302: the display apparatus determines whether a Bluetooth connection is established between the display apparatus and the hearing aid supporting HAS.

In the above step S1302, if the display apparatus has not established a Bluetooth connection with the hearing aid supporting HAS, the following step S1303 is executed.

The display apparatus fails to establish a Bluetooth connection with the hearing aid supporting HAS in the following cases.

Case 1: the display apparatus has not established a Bluetooth connection with other devices.

Case 2: the display apparatus has established a Bluetooth connection with other devices other than the hearing aid.

Case 3: the display apparatus has established a Bluetooth connection with a hearing aid that does not support HAS.

S1303: the display apparatus adjusts the volume of the display apparatus according to the third volume adjustment instruction.

As described in the above example, the third volume adjustment instruction is a third volume adjustment instruction for increasing the volume value by 1. If the current volume value of the display apparatus is 5, the volume value of the display apparatus is increased by 1 by executing the third volume adjustment instruction, thereby adjusting the volume value of the display apparatus to 6.

In the above step S1302, if the display apparatus establishes a Bluetooth connection with the hearing aid supporting HAS, the following step S1304 is executed.

S1304: the display apparatus displays a volume adjustment object selection interface.

The volume adjustment object selection interface includes a first control for representing the display apparatus and a second control for representing the hearing aid.

That is, the display apparatus displays the volume adjustment object selection interface through the display.

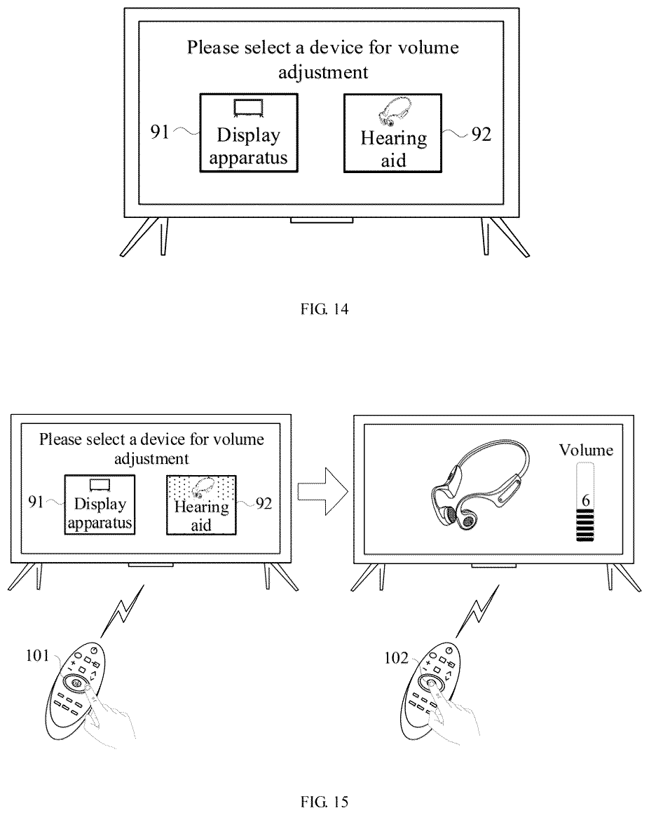

In one embodiment of the present disclosure, as shown in FIG. 14, in some embodiments, the volume adjustment object selection interface includes: a prompt “Please select a device for volume adjustment”, a first control 91 for representing the display apparatus, and a second control 92 for representing the hearing aid. The user can select the device for which the volume adjustment is desired according to the prompt, the first control 91, and the second control 92.

S1305: the display apparatus receives a selection operation.

The selection operation is an operation on the first control or the second control.

In some embodiments, the display apparatus receiving the selection operation can include: the remote controller generates the selection operation according to the user operating a physical button on the remote controller, and sends the selection operation to the display apparatus. For example, the user first selects the first control or the second control by inputting a direction key on the remote controller, and then confirms that the selected device is the device for which the volume is to be adjusted by inputting a confirmation key on the remote controller.

In one embodiment of the present disclosure, as shown in FIG. 15, the above embodiments are described by taking the user selecting a hearing aid as the device to be volume adjusted through a remote controller as an example. As shown in FIG. 15, the user first inputs the direction key 101 on the remote controller to select the second control in the volume adjustment object selection interface, and the display apparatus highlights the second control by making the second control border thicker, increasing the brightness of the second control, adding audio and video to the second control, etc., to indicate that the second control has been selected; then the confirmation key 102 on the remote controller 100 is input to determine the selected device (the device represented by the second control-the hearing aid) as the device to be volume adjusted, and the display apparatus further jumps to a hearing aid volume adjustment interface for adjusting the volume of the hearing aid.

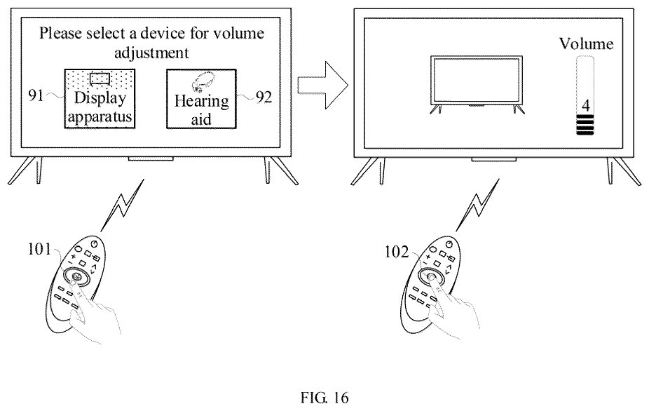

In some embodiments of the present disclosure, referring to FIG. 16, FIG. 16 takes the example of a user selecting a display apparatus as a device for volume adjustment through a remote control to illustrate the above embodiments. As shown in FIG. 16, the user first inputs the direction key 101 on the remote control to select the first control in the volume adjustment object selection interface. Similarly, the display apparatus can highlight the first control by making the border of the second control thicker, increasing the brightness of the second control, adding audio and video to the second control, etc., to indicate that the first control has been selected; then the confirmation key 102 on the remote control 100 is input to determine the selected device (the device represented by the second control-the display apparatus) as the device for volume adjustment, and the display apparatus further adjusts the volume according to a volume adjustment finger.

In the above step S1305, if the selection operation is an operation on the first control, it can be determined that the device for which the user wants to adjust the volume is the display apparatus, so the above step S1306 is executed, and the above step S1303 is executed, i.e., adjusting the volume of the display apparatus according to the third volume adjustment instruction.

S1306: the display apparatus determines that the third volume adjustment instruction is used to adjust the volume of the hearing aid.

In the above step S1305, if the selection operation is an operation on the second control, it can be determined that the device for which the user wants to adjust the volume is a hearing aid, and therefore the above step S1307 and subsequent steps are executed.

S1307: the display apparatus determines that the third volume adjustment instruction is used to adjust the volume of the display apparatus.

S1308: the display apparatus forwards the third volume adjustment instruction to the hearing aid through the Bluetooth connection.

In response, the hearing aid receives the third volume adjustment instruction forwarded by the display apparatus through the Bluetooth connection.

S1309: the volume of the hearing aid is adjusted according to the third volume adjustment instruction.

As described in the above example, the third volume adjustment instruction is a third volume adjustment instruction for increasing the volume value by 1. If the current volume value of the hearing aid is 8, the hearing aid increases the volume value by 1 by executing the third volume adjustment instruction, thereby adjusting the volume value of the hearing aid to 9.

In the above embodiments, when the display apparatus receives the third volume adjustment instruction and a Bluetooth connection is established between the display apparatus and the hearing aid supporting HAS, the display apparatus displays a volume adjustment object selection interface, and the user can choose to adjust the volume of the display apparatus or the hearing aid by the displayed volume adjustment object selection interface. Therefore, the above embodiments can further meet possible volume adjustment needs, thereby improving the user experience.

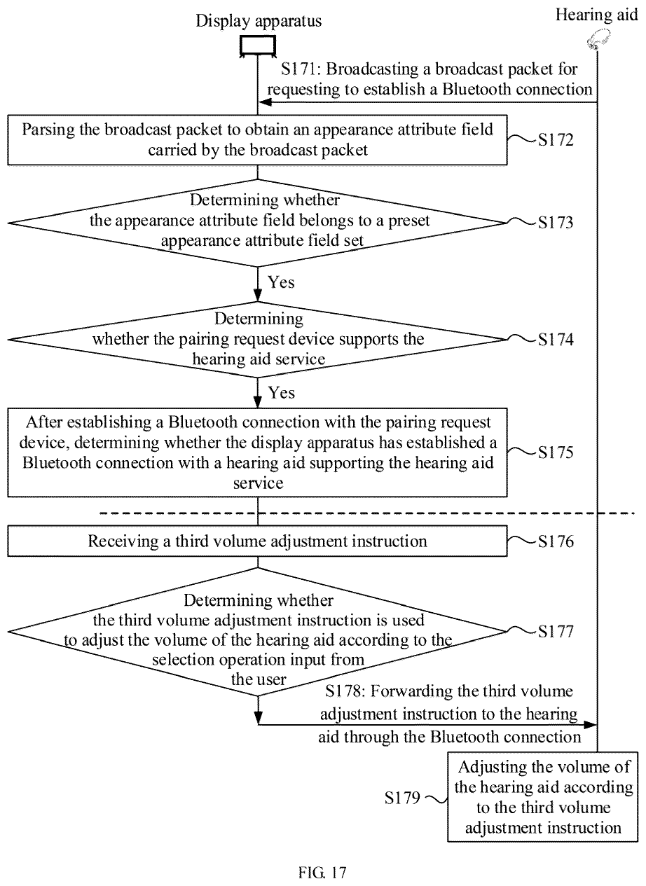

FIG. 17 is a schematic diagram of an interactive flow of another volume adjustment method shown in embodiments of the present disclosure. As shown in FIG. 17, the method includes the following steps.

S171: the hearing aid broadcasts a broadcast packet for requesting to establish a Bluetooth connection.

The broadcast packet carries an appearance attribute field of the hearing aid.

In a certain embodiment of the present disclosure, when the hearing aid is a hearing aid of no special type, the appearance attribute field carried by the broadcast packet can be “Hearing Aid”; when the hearing aid is a generic hearing aid, the appearance attribute field carried by the broadcast packet can be “Generic Hearing Aid”; when the hearing aid is an in-ear hearing aid, the appearance attribute field carried by the broadcast packet can be “In-ear Hearing Aid”; when the hearing aid is a behind-the-ear hearing aid, the appearance attribute field carried by the broadcast packet can be “Behind-ear Hearing Aid”.

Since the broadcast packet is sent by broadcasting, when the display apparatus is located in a sending range of the broadcast packet of the hearing aid, the display apparatus can receive the broadcast packet sent from the hearing aid for requesting to establish a Bluetooth connection with the display apparatus.

S172: the display apparatus parses the broadcast packet to obtain an appearance attribute field carried by the broadcast packet.

That is, the display apparatus extracts the field corresponding to the appearance attribute field according to the Bluetooth configuration protocol, thereby obtaining the appearance attribute field carried by the broadcast packet.

S173: the display apparatus determines whether the appearance attribute field belongs to a preset appearance attribute field set.

The preset appearance attribute field set includes appearance attribute fields of at least one type of hearing aid.

It should be noted that in order to more accurately identify whether a Bluetooth pairing device is a hearing aid, the preset appearance attribute field set should include appearance attribute fields of various types of hearing aids as much as possible. In some embodiments, the preset appearance attribute field set can include appearance attribute fields of hearing aids such as “Hearing Aid”, “Generic Hearing Aid”, “In-ear Hearing Aid”, and “Behind-ear Hearing Aid”.

In the above step S173, if the appearance attribute field does not belong to the preset appearance attribute field set, it can be determined that the current pairing request device is not a hearing aid, so the current Bluetooth connected device can be marked as not a hearing aid through the system attribute method, and synchronized to the audio control module, and the Bluetooth connection is established with the pairing request device. When the third volume adjustment instruction is received later, the audio control module adjusts the volume of the display apparatus according to the received third volume adjustment instruction.

In the above step S173, if the appearance attribute field belongs to the preset appearance attribute field set, the following step S174 is executed.

S174: The display apparatus determines whether the pairing request device supports the hearing aid service.

In some embodiments, the display apparatus determining whether the pairing request device (hearing aid) supports the hearing aid service can include the following steps 1 to 5.

Step 1: the display apparatus sends a service query request to the pairing request device during the process of establishing a Bluetooth connection with the pairing request device.

Step 2: the pairing request device sends a service query response to the display apparatus.

The service query response carries a universally unique identifier (UUID) of each service supported by the pairing request device.

That is, if the hearing aid supports HAS, the UUID of HAS is carried in the service query response, and if the hearing aid does not support HAS, the UUID of HAS is not carried in the service query response.

In some embodiments, the display apparatus can send a service query request to the pairing request device via an attribute protocol (ATT), and the pairing request device can also send a service query response to the display apparatus via ATT.

In some embodiments, the service query response can be as shown in Table 3 below.

TABLE 3

| UUID | Name of Service |
|---|---|
| 0x1800 | Generic Access |
| 0x1801 | Generic Attribute |
| 0x1803 | Link Loss |
| 0x1804 | Tx Power |
| 0x1853 | Common Audio Service |
| 0x1854 | Hearing Access Service |
| 0x1855 | TMAS Service |
| . . . | . . . |

Step 3: determining whether the service query response carries the universally unique identifier of the hearing aid service.

In some embodiments, the UUID of the hearing aid service is 0×1855, so determining whether the service query response carries the universally unique identifier of the hearing aid

In the above step 3, if the service query response carries the universally unique identifier of the hearing aid service, then the following step 4 is executed, and if the service query response does not carry the universally unique identifier of the hearing aid service, then the following step 5 is executed.

Step 4: the display apparatus determines that the pairing request device supports the hearing aid service.

Step 5: the display apparatus determines that the pairing request device does not support the hearing aid service.

If the display apparatus determines that the pairing request device supports the hearing aid service, the display apparatus can mark the current Bluetooth connected device as a hearing aid that supports the hearing aid service through the system attribute method, and synchronize the device to the audio control module. If the display apparatus determines that the pairing request device does not support the hearing aid service, the display apparatus can mark the current Bluetooth connected device as a hearing aid that does not support the hearing aid service through the system attribute method, and synchronize the device to the audio control module.

In the above step S174, if the display apparatus determines that the pairing request device supports the hearing aid service, the following step S175 is executed.

S175: after establishing a Bluetooth connection with the pairing request device, determining whether the display apparatus has established a Bluetooth connection with a hearing aid supporting the hearing aid service.

S176: the display apparatus receives a third volume adjustment instruction.

S177: the display apparatus determines whether the third volume adjustment instruction is used to adjust the volume of the hearing aid according to the selection operation input from the user.

In the above step S177, if the third volume adjustment instruction is used to adjust the volume of the hearing aid, the following step S178 is executed.

S178: the display apparatus forwards the third volume adjustment instruction to the hearing aid through the Bluetooth connection.

Correspondingly, the hearing aid receives the third volume adjustment instruction sent from the display apparatus through the Bluetooth connection.

S179: the volume of the hearing aid is adjusted according to the third volume adjustment instruction.

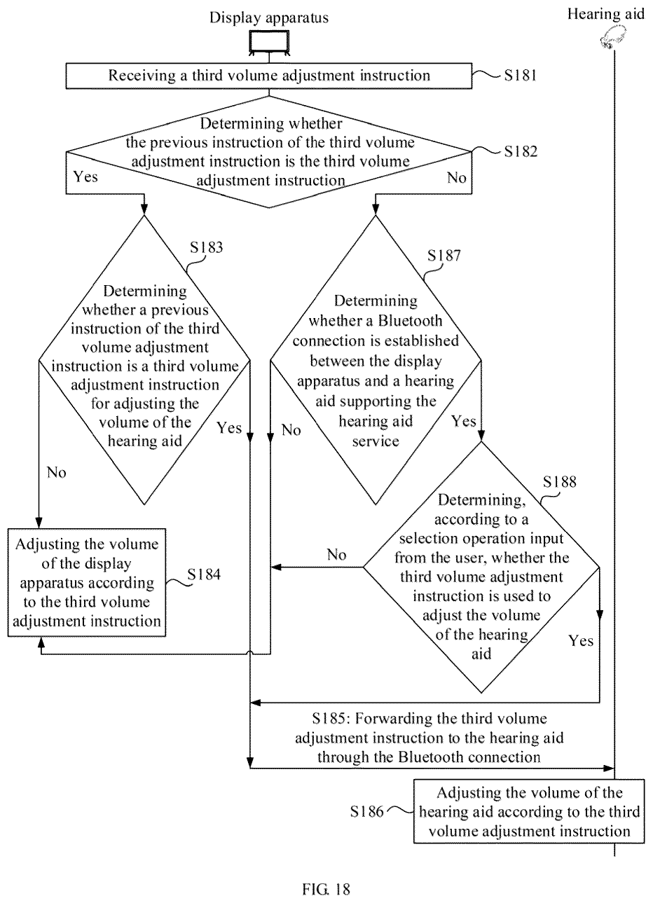

FIG. 18 is a schematic diagram of an interaction process of another volume adjustment method in the embodiments of the present disclosure. As shown in FIG. 18, the method includes the following steps.

S181: the display apparatus receives a third volume adjustment instruction.

S182: the display apparatus determines whether the previous instruction of the third volume adjustment instruction is the third volume adjustment instruction.

That is, the display apparatus determines whether the control instruction received latest before receiving the third volume adjustment instruction is also the third volume adjustment instruction.

In the above step S182, if the previous instruction of the third volume adjustment instruction is also the third volume adjustment instruction, the following step S183 is executed.

S183: the display apparatus determines whether a previous instruction of the third volume adjustment instruction is a third volume adjustment instruction for adjusting the volume of the hearing aid.

In the above step S182, if the previous instruction of the third volume adjustment instruction is a third volume adjustment instruction for adjusting the volume of the display apparatus, the following step S184 is executed, and if the previous instruction of the third volume adjustment instruction is a third volume adjustment instruction for adjusting the volume of the hearing aid, the following steps S185 and S186 are executed.

S184: the display apparatus adjusts the volume of the display apparatus according to the third volume adjustment instruction.

S185: the display apparatus forwards the third volume adjustment instruction to the hearing aid through the Bluetooth connection.

Correspondingly, the hearing aid receives the third volume adjustment instruction sent by the display apparatus through the Bluetooth connection.

S186: the volume of the hearing aid is adjusted according to the third volume adjustment instruction.

In the above step S182, if the previous instruction of the third volume adjustment instruction is not the third volume adjustment instruction, the process goes to the following step S187.

S187: the display apparatus determines whether a Bluetooth connection is established between the display apparatus and a hearing aid supporting the hearing aid service.

In the above step S187, if the display apparatus has not established a Bluetooth connection with the hearing aid supporting the hearing aid service, the process returns to execute the above step S184, and the volume of the display apparatus is adjusted according to the third volume adjustment instruction.

In the above step S187, if the display apparatus has established a Bluetooth connection with the hearing aid supporting the hearing aid service, the following step S188 is executed to adjust the volume of the display apparatus according to the third volume adjustment instruction.

S188: the display apparatus determines, according to a selection operation input from the user, whether the third volume adjustment instruction is used to adjust the volume of the hearing aid.

In the above step S188, if the third volume adjustment instruction is used to adjust the volume of the display apparatus, then the process returns to execute the above step S184 to adjust the volume of the display apparatus according to the third volume adjustment instruction.

In the above step S188, if the third volume adjustment instruction is used to adjust the volume of the display apparatus, then the process returns to the above steps S185 and S186, and the display apparatus forwards the third volume adjustment instruction to the hearing aid through the Bluetooth connection, and the hearing aid adjusts the volume according to the third volume adjustment instruction. After receiving the third volume adjustment instruction, the display apparatus first determines whether the previous instruction is the third volume adjustment instruction, and when the previous instruction is also the third volume adjustment instruction and the previous instruction is the third volume adjustment instruction for adjusting the volume of the display apparatus, the volume of the display apparatus is adjusted according to the third volume adjustment instruction, and when the previous instruction is also the third volume adjustment instruction and the previous instruction is the third volume adjustment instruction for adjusting the volume of the hearing aid, the volume of the hearing aid is adjusted according to the third volume adjustment instruction. Therefore, the above embodiments can avoid repeatedly requiring the user to select the volume adjustment object during continuous volume adjustment, thereby simplifying the volume adjustment operation and improving the volume adjustment efficiency.

What is claimed is:

1. A display apparatus, comprising:
a display, configured to display an image and/or a user interface;
a user input interface, configured to receive a command from a user;
a communicator, configured to communicate with an external device according to a predetermined protocol;
a memory, configured to store computer instructions and data associated with the display apparatus;
at least one processor, in connection with the display, the input user interface, the communicator and the memory, and configured to execute the computer instructions to cause the display apparatus to:
receive a first volume adjustment instruction;
adjust a volume of the display apparatus according to the first volume adjustment instruction, and based on that a Bluetooth connection is established between the display apparatus and a hearing aid supporting a hearing aid service (HAS), obtain a first volume value and a second volume value; wherein the first volume value is a volume value of the display apparatus after adjusting the volume of the display apparatus according to the first volume adjustment instruction, and the second volume value is a volume value of the hearing aid;
based on that a condition for adjusting a volume of the hearing aid is met according to the first volume value and the second volume value, obtain loudness of an ambient sound;
generate a second volume adjustment instruction according to the loudness of the ambient sound; and
send the second volume adjustment instruction to the hearing aid via the Bluetooth connection to adjust the volume of the hearing aid.

2. The display apparatus according to claim 1, wherein the at least one processor is further configured to execute the computer instructions to cause the display apparatus to:
obtain a first volume difference, wherein the first volume difference is an absolute value of a difference between the first volume value and the second volume value;
determine whether the first volume difference is greater than a preset threshold;
based on that the first volume difference is greater than the preset threshold, determine that the condition for adjusting the volume of the hearing aid is met;
based on that the first volume difference is not greater than the preset threshold, determine that the condition for adjusting the volume of the hearing aid is not met.

3. The display apparatus according to claim 1, wherein the at least one processor is further configured to execute the computer instructions to cause the display apparatus to:
obtain a target volume value according to the loudness of the ambient sound and a preset mapping relationship; wherein the preset mapping relationship comprises a mapping relationship between loudness of each ambient sound and a volume value;
generate the second volume adjustment instruction according to the target volume value and the second volume value.

4. The display apparatus according to claim 3, wherein the at least one processor is further configured to execute the computer instructions to cause the display apparatus to:
obtain a second volume difference, wherein the second volume difference is an absolute value of a difference between the target volume value and the second volume value;
generate one or more volume adjustment instructions for controlling the volume value of the hearing aid to increase or decrease, wherein a number of the volume adjustment instructions is equal to a value of the second volume difference.

5. The display apparatus according to claim 1, wherein the at least one processor is further configured to execute the computer instructions to cause the display apparatus to:
obtain a target volume value according to the loudness of the ambient sound and a preset mapping relationship; wherein the preset mapping relationship comprises a mapping relationship between loudness of each ambient sound and a volume value;
generate a volume adjustment instruction for controlling the volume value of the hearing aid to be adjusted to the target volume value.

6. The display apparatus according to claim 1, wherein the at least one processor is further configured to execute the computer instructions to cause the display apparatus to:
when receiving a broadcast packet sent from a pairing request device for establishing a Bluetooth connection between the display apparatus and the pairing request device, parse the broadcast packet to obtain an appearance attribute field carried by the broadcast packet;
determine whether the appearance attribute field belongs to a preset appearance attribute field set, wherein the preset appearance attribute field set comprises appearance attribute fields of at least one type of hearing aid;
based on that the appearance attribute field belongs to the preset appearance attribute field set, determine whether the pairing request device supports the HAS;
based on that the pairing request device supports the HAS, after establishing the Bluetooth connection between the display apparatus and the pairing request device, determine that the Bluetooth connection has been established between the display apparatus and the hearing aid supporting the HAS.

7. The display apparatus according to claim 6, wherein the communicator is further configured to send a service query request to the pairing request device during the establishment of the Bluetooth connection between the display apparatus and the pairing request device, and receive a service query response sent from the pairing request device, wherein the service query response carries a universally unique identifier of each service supported by the pairing request device;
the at least one processor is further configured to execute the computer instructions to cause the display apparatus to:
determine whether the service query response carries a universally unique identifier of the HAS; based on that the service query response carries the universally unique identifier of the HAS, determine that the pairing request device supports the HAS; based on that the service query response does not carry the universally unique identifier of the HAS, determine that the pairing request device does not support the HAS.

8. The display apparatus according to claim 1, wherein the user input interface is further configured to receive a third volume adjustment instruction;
wherein the at least one processor is further configured to execute the computer instructions to cause the display apparatus to determine whether the Bluetooth connection has been established between the display apparatus and the hearing aid supporting the HAS; and
based on that the Bluetooth connection has been established between the display apparatus and the hearing aid supporting the HAS, determine, according to a selection operation input from the user, whether the third volume adjustment instruction is used for adjusting the volume of the hearing aid;
wherein the communicator is further configured to forward the third volume adjustment instruction to the hearing aid through the Bluetooth connection to adjust the volume of the hearing aid based on that the third volume adjustment instruction is used for adjusting the volume of the hearing aid.

9. The display apparatus according to claim 8, wherein the display is further configured to display a volume adjustment object selection interface based on that the Bluetooth connection has been established between the display apparatus and the hearing aid supporting the HAS;
the volume adjustment object selection interface comprises a first control for representing the display apparatus and a second control for representing the hearing aid;
wherein the user input interface is further configured to receive a selection operation; the selection operation is an operation on the first control or the second control;
wherein the at least one processor is further configured to execute the computer instructions to cause the display apparatus to determine that the third volume adjustment instruction is used for adjusting the volume of the hearing aid based on that the selection operation is the operation on the first control, and determine that the third volume adjustment instruction is used for adjusting the volume of the display apparatus based on that the selection operation is the operation on the second control.

10. The display apparatus according to claim 9, wherein the at least one processor is further configured to execute the computer instructions to cause the display apparatus to:
based on that the third volume adjustment instruction is used for adjusting the volume of the display apparatus, adjust the volume of the display apparatus according to the third volume adjustment instruction.

11. The display apparatus according to claim 8, wherein the at least one processor is further configured to execute the computer instructions to cause the display apparatus to:
when receiving a broadcast packet sent from a pairing request device for establishing a Bluetooth connection between the display apparatus and the pairing request device, parse the broadcast packet to obtain an appearance attribute field carried by the broadcast packet;
determine whether the appearance attribute field belongs to a preset appearance attribute field set, wherein the preset appearance attribute field set comprises appearance attribute fields of at least one type of hearing aid;
based on that the appearance attribute field belongs to the preset appearance attribute field set, determine whether the pairing request device supports the HAS;
based on that the pairing request device supports the HAS, after establishing the Bluetooth connection between the display apparatus and the pairing request device, determine that the Bluetooth connection has been established between the display apparatus and the hearing aid supporting the HAS.

12. The display apparatus according to claim 11, wherein the communicator is further configured to send a service query request to the pairing request device during the establishment of the Bluetooth connection between the display apparatus and the pairing request device, and receive a service query response sent from the pairing request device, wherein the service query response carries a universally unique identifier of each service supported by the pairing request device;
the at least one processor is further configured to execute the computer instructions to cause the display apparatus to:
determine whether the service query response carries a universally unique identifier of the HAS; based on that the service query response carries the universally unique identifier of the HAS, determine that the pairing request device supports the HAS; based on that the service query response does not carry the universally unique identifier of the HAS, determine that the pairing request device does not support the HAS.

13. The display apparatus according to claim 8, wherein the at least one processor is further configured to execute the computer instructions to cause the display apparatus to:
before determining whether the Bluetooth connection has been established between the display apparatus and the hearing aid supporting the HAS, determine whether a previous instruction before the third volume adjustment instruction is the third volume adjustment instruction;
based on that the previous instruction before the third volume adjustment instruction is the third volume adjustment instruction, determine whether the previous instruction before the third volume adjustment instruction is the third volume adjustment instruction for adjusting the volume of the hearing aid;
based on that the previous instruction before the third volume adjustment instruction is the third volume adjustment instruction for adjusting the volume of the hearing aid, forward the third volume adjustment instruction to the hearing aid via the Bluetooth connection to adjust the volume of the hearing aid.

14. The display apparatus according to claim 13, wherein the at least one processor is further configured to execute the computer instructions to cause the display apparatus to:
based on that the previous instruction before the third volume adjustment instruction is the third volume adjustment instruction for adjusting the volume of the display apparatus, adjust the volume of the display apparatus according to the third volume adjustment instruction.

15. A volume adjustment method for a display apparatus, comprising:
receiving a first volume adjustment instruction;
adjusting a volume of the display apparatus according to the first volume adjustment instruction;
based on that a Bluetooth connection is established between the display apparatus and a hearing aid supporting a hearing aid service (HAS), obtaining a first volume value and a second volume value; wherein the first volume value is a volume value of the display apparatus after adjusting the volume of the display apparatus according to the first volume adjustment instruction, and the second volume value is a volume value of the hearing aid;
based on that a condition for adjusting a volume of the hearing aid is met according to the first volume value and the second volume value, obtaining loudness of an ambient sound;
generating a second volume adjustment instruction according to the loudness of the ambient sound; and
sending the second volume adjustment instruction to the hearing aid via the Bluetooth connection to adjust the volume of the hearing aid.

16. The method according to claim 15, further comprising:
obtaining a first volume difference, wherein the first volume difference is an absolute value of a difference between the first volume value and the second volume value;
determining whether the first volume difference is greater than a preset threshold;
based on that the first volume difference is greater than the preset threshold, determining that the condition for adjusting the volume of the hearing aid is met;
based on that the first volume difference is not greater than the preset threshold, determining that the condition for adjusting the volume of the hearing aid is not met.

17. The method according to claim 15, further comprising:
obtaining a target volume value according to the loudness of the ambient sound and a preset mapping relationship; wherein the preset mapping relationship comprises a mapping relationship between loudness of each ambient sound and a volume value;
generating the second volume adjustment instruction according to the target volume value and the second volume value.

18. The method according to claim 17, further comprising:
obtaining a second volume difference, wherein the second volume difference is an absolute value of a difference between the target volume value and the second volume value;
generating one or more volume adjustment instructions for controlling the volume value of the hearing aid to increase or decrease, wherein a number of the volume adjustment instructions is equal to a value of the second volume difference.

19. The method according to claim 15, further comprising:
obtaining a target volume value according to the loudness of the ambient sound and a preset mapping relationship; wherein the preset mapping relationship comprises a mapping relationship between loudness of each ambient sound and a volume value;
generating a volume adjustment instruction for controlling the volume value of the hearing aid to be adjusted to the target volume value.

20. The method according to claim 15, further comprising:
when receiving a broadcast packet sent from a pairing request device for establishing a Bluetooth connection between the display apparatus and the pairing request device, parsing the broadcast packet to obtain an appearance attribute field carried by the broadcast packet;
determining whether the appearance attribute field belongs to a preset appearance attribute field set, wherein the preset appearance attribute field set comprises appearance attribute fields of at least one type of hearing aid;
based on that the appearance attribute field belongs to the preset appearance attribute field set, determining whether the pairing request device supports the HAS;
based on that the pairing request device supports the HAS, after establishing the Bluetooth connection between the display apparatus and the pairing request device, determining that the Bluetooth connection has been established between the display apparatus and the hearing aid supporting the HAS.
